(19) United States
(12) Patent Application Publication
(10) Pub. No.: US 2007/0179635 A1
(43) Pub. Date: Aug. 2, 2007

(54) Method and article of manufacure to persistently deconfigure connected elements

(75) Inventors: Sheldon R. Bailey, Rochester, MN (US); Melissa J. Connell, Rochester, MN (US); Michael E. Plute, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/344,930

(22) Filed: Feb. 1, 2006

(51) Int. Cl. G05B 11/01

(52) U.S. Cl. 700/21

(57) ABSTRACT

Embodiments of the present invention provide methods and systems for optimizing system configuration after replacement of one or more defective devices in the system. Upon detection of a failure in the system, one or more devices may be identified as failing devices. The devices may be grouped in an error log maintained by the operating system, and excluded from the system during configuration. A priority for each device in the group may indicate the likelihood that the device is the failure causing device. When a device from a group is replaced, devices connected with the replaced device may be cleared for configuration into the system, thereby eliminating the need for manual intervention to clear the devices.

### BACKGROUND OF THE INVENTION

1. Field of the Invention

The present invention generally relates to data processing systems. More specifically, the invention relates to providing an optimal system configuration after replacing one or more defective devices in the system.

2. Description of the Related Art

Data processing system generally include one or more processors, one or more levels of cache, and a plurality of memory and Input/Output (IO) devices connected over one or more buses. An external bus interface such as a memory or IO controller may be used to transfer the data processed by the system between the devices.

Data processing systems, such as the one described above, may often experience hardware failures that may affect the availability of the system. To enhance the availability of such systems, several advanced features such as deallocation of failing devices may be incorporated in the system.

Deallocation provides a mechanism for marking system components as unavailable and preventing them from being configured into the system during the system boot process. Deallocation of devices may also occur if an unrecoverable error occurs during run time or if the device exceeds a certain threshold of recoverable errors during run time.

One problem with this approach is that sometimes the data processing system may contain complicated interconnections between hardware devices which make it difficult to identify a particular device as the device causing the hardware failure. Therefore, a list of potential failure causing devices may be identified. The devices identified as potential failure causing devices may be excluded during the next system configuration.

Because a specific device cannot be identified as the failure causing device, all or most of the devices in the list may be replaced. Under this scheme, a large number of devices may be replaced even though the devices in the list do not cause failures.

Yet another problem with this approach is that while replaced devices may be included in the system at the next system configuration, devices associated with the replaced failing device may still be excluded from the system even though corrective measures have already been taken. Such devices must be manually cleared for inclusion in the system.

Therefore, what is needed are methods and systems for reducing the number of devices replaced in the system and for eliminating the manual intervention required to clear devices in the list that were not replaced.

### SUMMARY OF THE INVENTION

The present invention generally provides methods and systems for optimizing system configuration after replacing one or more defective devices in the system.

One embodiment of the invention provides a method for configuring a system. The method generally includes determining whether a device within the system has been replaced, wherein the replaced device is associated with a previous failure in the system and identified as unavailable for configuration into the system, and in response to determining that a device is replaced, determining whether one or more other devices are associated with the device, wherein the one or more other devices are associated with the failure and identified as unavailable for configuration into the system. The method further includes identifying the one or more other devices as available for configuration into the system.

Another embodiment of the invention provides computer readable storage medium containing a program for configuring a system. The program, when executed, performs operations generally comprising determining whether a device within the system has been replaced, wherein the replaced device is associated with a previous failure in the system and identified as unavailable for configuration into the system, and in response to determining that a device is replaced, determining whether one or more other devices are associated with the device, wherein the one or more other devices are associated with the failure and identified as unavailable for configuration into the system. The operations further include identifying the one or more other devices as available for configuration into the system.

Yet another embodiment of the invention provides a system comprising one or more processors and memory comprising a system configuration program. The system configuration program, when executed by the one or more processors is generally configured to determine whether a device within the system has been replaced, wherein the replaced device is associated with a previous failure in the system and identified as unavailable for configuration into the system, and in response to determining that a device is replaced, determine whether one or more other devices are associated with the device, wherein the one or more other devices are associated with the failure and identified as unavailable for configuration into the system. The system configuration program is further configured to identify the one or more other devices as available for configuration into the system.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an illustration of an exemplary system according to one embodiment of the invention.

FIG. 2 is a flow diagram of exemplary operations performed during IPL to identify failing devices, according to an embodiment of the invention.

FIG. 3 is a flow diagram of exemplary operations performed to determine failing devices at run time, according to an embodiment of the invention.

FIG. 4 is a flow diagram of exemplary operations performed to configure the system after replacement of a failing device, according to an embodiment of the invention.

### DETAILED DESCRIPTION OF THE PREFERRED EMBODIMENTS

Embodiments of the present invention provide methods and systems for optimizing system configuration after replacement of one or more defective devices in the system. Upon detection of a failure in the system, one or more devices may be identified as failing devices. The devices may be grouped in an error log maintained by the operating system, and excluded from the system during configuration. A priority for each device in the group may indicate the likelihood that the device is the failure causing device. When a device from a group is replaced, devices connected with the replaced device in a failing group may be cleared for configuration into the system, thereby eliminating the need for manual intervention to clear the devices.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

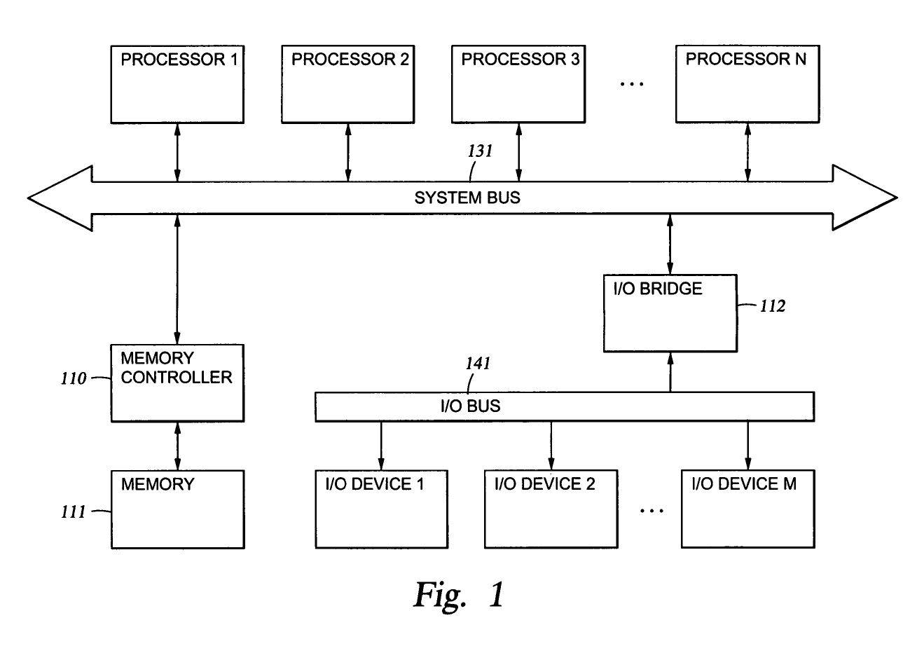

One embodiment of the invention is implemented as a program product for use with a computer system such as, for example, computer system 100 shown in FIG. 1 and described below. The program(s) of the program product defines functions of the embodiments (including the methods described herein) and can be contained on a variety of computer-readable storage media. Illustrative computer-readable storage media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Exemplary System

FIG. 1 illustrates an exemplary system 100 in which embodiments of the invention may be implemented. System 100 may include a plurality of processors 1 -n, memory controller 110 memory 111, IO bridge 112, and a plurality of IO devices 1-m. Processors 1-n may be connected to a system bus 131. While a plurality of processors are shown herein, one skilled in the art will however realize that, alternatively, a single processor system may also be implemented. The processors 1-nmay be configured to receive one or more commands and data from memory 111 or IO devices 1-m and execute the commands to process data.

For example, processor 1 may retrieve data from memory 111 by performing a read access. Subsequently, in response to receiving a command from an IO device, processor 1 may perform an ALU operation on the data. Processor 1 may then store the result of the data to memory by performing a write access on memory 110.

Memory 111 is preferably a random access memory such as a Dynamic Random Access Memory (DRAM). Memory 111 may contain sufficient storage for data processed by processors 1-n. While a single memory device 111 is shown, one skilled in the art will recognize that any number of memory devices may be included in the system. Memory 111 may be accessed exclusively by one of processors 1-n or shared by one or more of processors 1-n.

While not shown in the figure, one skilled in the art will however recognize that one or more levels of cache may also exist between the processors and memory 111. The cache memory may also be random access memory such as Static Random Access Memory (SRAM). Cache memory may be exclusively accessed by a processor or shared between the processors.

Memory controller 110 may be connected to system bus 111 and may provide an interface to memory 111. Similarly, IO bridge 112 may also be connected to system bus 112 and may provide an interface to IO bus 141. IO devices 1-m may be connected to IO bus 141. Illustrative IO devices include video cards, sound cards, graphics processing units, and the like configured to issue commands and receive responses from the CPU.

Identifying Failing Devices

Embodiments of the present invention may provide mechanisms to detect failing devices in a data processing system such as system 100. For example, the data processing system may be configured to detect failing devices during the Initial Program Load (IPL) stage. The initial program load is a process of taking the system from a powered off or non running state to the point of loading operating system code.

The IPL stage may include testing devices to determine whether the devices are functional. For example, some devices may include self testing circuitry. Such devices may perform a Built In Self Test (BIST) by means of the self testing circuitry before the device becomes operational. Testing may also include performing a Power On Self Test (POST) in which a component or part of the system is tested with system power to the component or part of the system.

The operating system may maintain an error log of devices identified as failing IPL testing. As previously described, due to the complexity and interconnectedness of devices, one or more devices may be identified as failing devices for each failure. The operating system may mark each of the devices as unavailable for system configuration. The devices associated with a particular failure may be grouped together. For each group, a priority may be set for each device indicating the likelihood that the device is the device causing the failure. For example, devices that are most likely to be the cause of failure may receive the highest priorities.

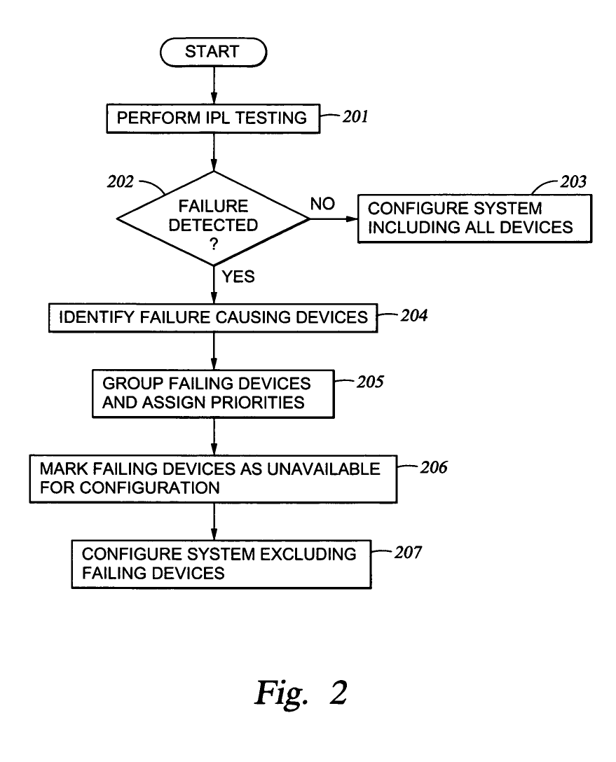

FIG. 2 is a flow diagram of exemplary operations performed to identify failing devices during IPL. The operations begin in step 201 by testing the devices in the system. As described above, testing may include self testing by the device or system testing. If no failures are detected in step 202, all devices may be configured into the system in step 203.

If, on the other hand, a failure is detected in step 202, one or more devices may be identified as the failing devices in step 204. In step 205, the failing devices may be grouped, and a priority may be assigned to each device. The priorities, for example, may indicate the likelihood that the device caused the failure. In step 206, the failing devices may be marked as unavailable for the next system configuration. In step 207, the system may be configured by excluding the failing devices. The list of failing devices and their groupings may be maintained by the operating system. The list for example may be examined during subsequent system configurations to exclude the identified failing devices from the system.

Failing devices may also be identified during run time. For example, a device may be deemed to be a failing device if a failing condition occurs. The failing condition may be a single condition, such as a failure to respond to a request for data. The failing condition may also occur if a threshold of errors is exceeded by the device.

If a failure is detected during run time, one or more devices may be identified as devices causing the failure. The operating system may mark each of the failing devices as unavailable for the next system configuration. The devices associated with the failure may be grouped together. A priority may also be set for each device indicating the likelihood that a particular device is the device causing the failure. For example, devices that are most likely the cause of failure may receive the highest priority.

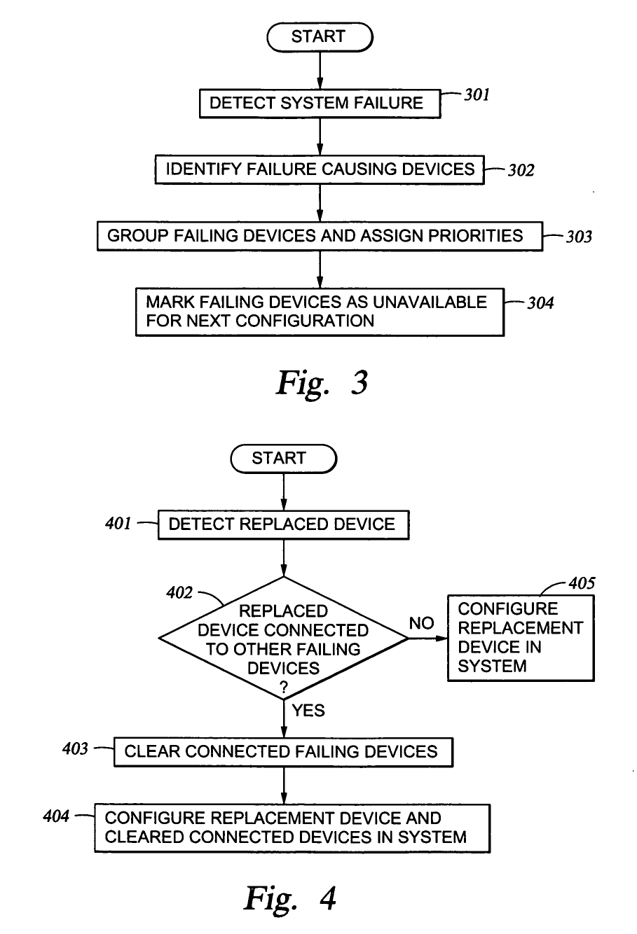

FIG. 3 is a flow diagram of exemplary operations performed to identify failing devices during run time. The operations begin in step 301 by detecting a failure in the system. As described above, detecting a failure may include detecting a single failing condition or a threshold number of errors. If a failure is detected in step 302, one or more devices may be identified as the failing devices. In step 303, the devices may be grouped together and a priority may be assigned to each device. The priorities, for example, may indicate the likelihood that the device caused the failure. In step 304, the failing devices may be marked as unavailable for the next configuration cycle. The list of devices and their groupings may be maintained by the operating system. The list for example may be examined during the next system configuration to exclude the identified failing devices from the system.

Optimizing System Configuration after Device Replacement

One or more devices in a group of devices associated with a failure may be replaced to remove the failing condition. For example, one or more devices with the highest priorities in a group may be replaced. The replacement device may be included in the system at the next configuration because it may not be identified in the operating system's list of failing devices. However, the operating system's list may still contain those devices associated with the replaced failing device.

To avoid manually clearing each device associated with a replaced device, embodiments of the present invention provide mechanisms to clear the devices from the operating system's list. For example, when a replacement device is detected, the operating systems list may be examined to identify any devices grouped with the replaced device. Devices grouped with the replaced device may be cleared and marked as available for system configuration, thereby avoiding manual intervention.

FIG. 4 is a flow diagram of exemplary operations performed to clear devices associated with a replaced device in the operating system's list of failing devices. The operations begin in step 401 by detecting a replacement device. In step 402, the operating systems list of failing devices is examined to determine whether the replaced device was grouped with any other devices. If no connected devices are found, the replacement device may be configured into the system in step 405. If connected devices in a failing group are found, the connected devices may be marked as available for configuration into the system, in step 403. In step 404, the replacement device and the cleared connected devices may be configured into the system.

### CONCLUSION

By clearing devices connected with a replaced failing device for inclusion in the system, embodiments of the invention avoid the manual intervention required to clear such devices. Furthermore, by assigning priorities to failing devices, those devices with the highest likelihood of causing failure may be replaced, thereby reducing the number of devices replaced in the system and improving system availability.

While the foregoing is directed to embodiments of the present invention, other and further embodiments of the invention may be devised without departing from the basic scope thereof, and the scope thereof is determined by the claims that follow.

What is claimed is:

1. A method for configuring a system, comprising:
determining whether a device within the system has been replaced, wherein the replaced device is associated with a previous failure in the system and identified as unavailable for configuration into the system;
in response to determining that a device is replaced, determining whether one or more other devices are associated with the device, wherein the one or more other devices are associated with the failure and identified as unavailable for configuration into the system; and
identifying the one or more other devices as available for configuration into the system.

2. The method of claim 1, wherein the device and the one or more other devices have an associated priority, wherein the priority indicates the likelihood that an associated device is the cause of the failure.

3. The method of claim 2, wherein the device has the highest priority.

4. The method of claim 1, wherein the failure is a failure that occurred during the initial program load.

5. The method of claim 1, wherein the failure is a failure that occurred at run time.

6. The method of claim 1, wherein the failure is determined when a single failing event occurs in the system.

7. The method of claim 1, wherein the failure is determined when a threshold number of errors occur in the system.

8. A computer readable storage medium containing a program for configuring a system which, when executed, performs operations comprising:
determining whether a device within the system has been replaced, wherein the replaced device is associated with a previous failure in the system and identified as unavailable for configuration into the system;
in response to determining that a device is replaced, determining whether one or more other devices are associated with the device, wherein the one or more other devices are associated with the failure and identified as unavailable for configuration into the system; and
identifying the one or more other devices as available for configuration into the system.

9. The computer readable storage medium of claim 8, wherein the device and the one or more other devices have an associated priority, wherein the priority indicates the likelihood that an associated device is the cause of the failure.

10. The computer readable storage medium of claim 9, wherein the device has the highest priority.

11. The computer readable storage medium of claim 8, wherein the failure is a failure that occurred during the initial program load.

12. The computer readable storage medium of claim 8, wherein the failure is a failure that occurred at run time.

13. The computer readable storage medium of claim 8, wherein the failure is determined when one of a single failing condition and a threshold number of errors occur in the system.

14. A system, comprising:
one or more processors; and
memory comprising a system configuration program which, when executed by the one or more processors is configured to:
determine whether a device within the system has been replaced, wherein the replaced device is associated with a previous failure in the system and identified as unavailable for configuration into the system;
in response to determining that a device is replaced, determine whether one or more other devices are associated with the device, wherein the one or more other devices are associated with the failure and identified as unavailable for configuration into the system; and
identify the one or more other devices as available for configuration into the system.

15. The system of claim 14, wherein the device and the one or more other devices have an associated priority, wherein the priority indicates the likelihood that an associated device is the cause of the failure.

16. The system of claim 15, wherein the device has the highest priority.

17. The system of claim 14, wherein the failure is a failure that occurred during the initial program load.

18. The system of claim 14, wherein the failure is a failure that occurred at run time.

19. The system of claim 14, wherein the failure is determined when a single failing event occurs in the system.

20. The system of claim 14, wherein the failure is determined when a threshold number of errors occur in the system.
